(19) United States
(12) Patent Application Publication
(10) Pub. No.: US 2004/0051624 A1
(43) Pub. Date: Mar. 18, 2004

(54) Device for securing access to a content located inside an enclosure

(76) Inventors: Serge Cuenot, Montrouge Cedex (FR); Damien Mandy, Montrouge Cedex (FR)

Correspondence Address: ROSENTHAL & OSHA L.L.P., 1221 MCKINNEY AVENUE, SUITE 2800, HOUSTON, TX, 77010, US

(21) Appl. No.: 10/432,800

(22) PCT Filed: Nov. 1, 2001
(86) PCT No.: PCT/IB01/02062

(30) Foreign Application Priority Data
Dec. 1, 2000 (FR) 0015583

(51) Int. Cl. G07C 9/00

(52) U.S. Cl. 340/5.6; 340/5.73

(57) ABSTRACT

The enclosure (V) comprises a communication interface (ICV) with outside, means for processing (IDV, OCV) and means for transferring (OMV) the content and/or data concerning said content (C). The processing means (IDV, OCV) establish an authenticating function with homologous authenticating means (IDK) of a key (K) provided with at least an access right, via the communication interface (ICV) of the enclosure and an homologous communication interface (ICK) of the key (K). In case of positive authentication and positive verification of access right, the processing means of the enclosure (IDV, OCV) command the locking/unlocking means (SDV) to open the door (P). When the door is opened, the processing means of the enclosure (IDV, OCV) transfer the content and/or the content-related data derived from the transfer means of the enclosure (OMV) to the key of the enclosure, via the communication interface (ICV) of the enclosure and the homologous communication interface (ICK) of the key (K).

This invention relates to the securing of access to a content located inside an enclosure.

It may be applied generally for securing property, valuables, services or data contained in an enclosure such as a case or a box. It may be applied particularly for securing the property contained inside a Pay & Display terminal, a payphone or a similar device.

Devices for securing access to contents inside enclosures are known.

For example, in application WO-A-93/12510, access to the content of a Pay & Display terminal is secured by a card reader. An operator inserts a smart card in the reader. After authenticating the smart card and opening the door that prevents access to the content in the terminal, the smart card reads and records the data from a registry relating to the content of the terminal. After the data are recorded, the smart card opens the door in order to enable the required operations.

Such devices for securing access are not entirely satisfactory.

The card reader can recognise (and authenticate) the operator before opening the door and transfer content data to the smart card. But because the card reader is placed outside the terminal and the operator authentication stage is dissociated from the transfer of data relating to the content of the terminal, door opening and access to the content of the terminal, such readers do not cover the case of denial (after the fact) by the operator of access to the content of the terminal.

This invention makes up for that deficiency.

It relates to a device for securing access to a content located in an enclosure, which enclosure is of the type including a casing that prevents access to the said content, a door providing access to the inside of the said casing and means to lock and unlock the door.

According to the general definition of the invention, the enclosure also contains an interface for communicating with the outside, processing means and means for transferring the content and/or content data.

The said processing means are designed to establish an authentication function with the homologous authentication means of a key with at least one access right, via the communication interface of the enclosure and the homologous communication interface of the key.

If the authentication is positive and so is the right to access, the processing means of the enclosure are able to command the door locking/unlocking means.

If the door is opened, the enclosure processing means are designed to transfer the content and/or content data from the enclosure transfer means to the key via the enclosure communication interface and the homologous communication interface of the key.

In that way, thanks to the device according to the invention, the operator, who is responsible for transferring the content or the content data from the enclosure to the outside cannot dissociate the nature of his or her actions from the key given to access the said content. As a result, the securing device in the invention offers a service of non-denial of access to the content of the enclosure by the operator who opens the door of the enclosure.

In other words, the device according to the invention offers the dual benefit of preventing fraud (access to the content) by malicious individuals (locking function) and ensuring that the authenticated person who collects the cash cannot deny having had access to the content.

In practice, the processing means of the enclosure are designed to transfer the content and/or content data from the transfer means of the enclosure to the storage means of the key.

Consequently, thanks to the invention, locking and storage functions are added to the singularity of saving information only in the key that is used to open the lock (locking/unlocking means).

The authentication function is preferably of the active type.

According to another aspect of the invention, the communication interface of the enclosure is of the type belonging to the group formed by contactless, contact or combined technology.

This invention also covers a key designed to cooperate with a device for securing access to content located inside an enclosure of the type that has a casing preventing access to the said content, a door that provides access to the inside of the said casing and means for locking/unlocking the door.

According to another major characteristic of the invention, the key provides at least one access right and includes a communication interface designed to communicate with the homologous communication interface of the enclosure, processing means and storage means.

The said processing means of the key are designed to establish an authentication function with the homologous authentication means of the processing means of the enclosure via the communication interface of the key and the homologous communication interface of the enclosure, and

If the authentication and the verification of the access right are positive, the locking/unlocking means are designed to be controlled to open the door, and

If the door of the enclosure is opened, the processing means of the key are designed to transfer the content and/or the content data from the transfer means of the enclosure to the storage means of the key via the communication interface of the enclosure and the homologous communication interface of the key.

In practice, the communication interface of the key is of the type belonging to the group formed by contactless, contact or combined technology.

According to another aspect of the invention, information is exchanged between the communication interface of the enclosure and the communication interface of the key during all or part of the collection until the door is locked. Such exchange is able to provide information about the use of the key with the enclosure and/or disable/enable the access right of the key and/or the authentication means of the key on the basis of the use of the key with the enclosure.

If the collection process is not normal, for instance if the door is not locked, the processing means of the enclosure are capable of disabling the access right and/or the key authentication means.

Such disabling of the access right (all or part of the rights if several access rights are provided) of the key if the collection process is not normal is used to limit deliberate or involuntary doubtful operations by the operator, such as cases where the operator removes the key from the communication interface of the enclosure without closing and locking the door so as to leave the enclosure open and come back later to take the content without leaving a trail. Such an operation would disable the collection rights of the key, which could then not be used to collect other terminals, thereby preventing the collection of the said other terminals.

If the collection process is normal, the processing means of the enclosure can also disable the access right of the key after authenticating and verifying the access right and before opening (unlocking) the door. After closing (locking) the door, the processing means of the enclosure are designed to enable the said access right of the key.

The enabling/disabling of the access rights of the key, particularly in relation with the opening/closing of the door, means that a third party—e.g. the key administrator—can check the use of the key by a selected operator at a later time.

The other characteristics and benefits of the invention will become apparent with the detailed description below and the drawings, where:

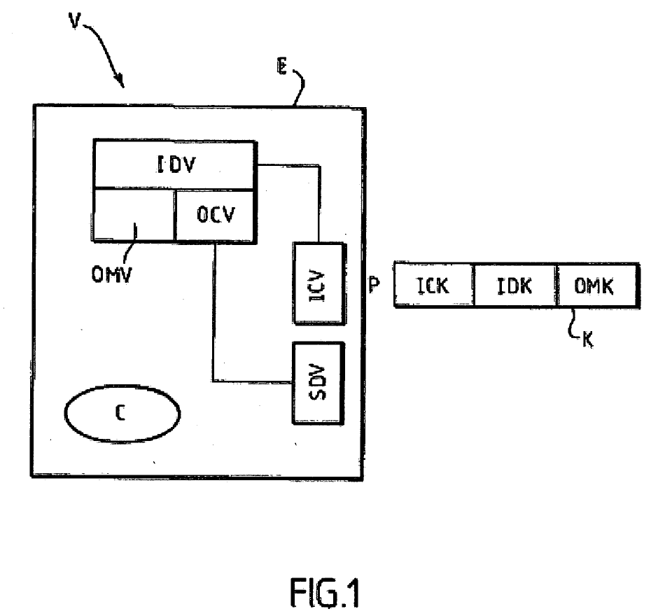

FIG. 1 is a schematic illustration of the means that make up the device for securing access to a content according to the invention, and

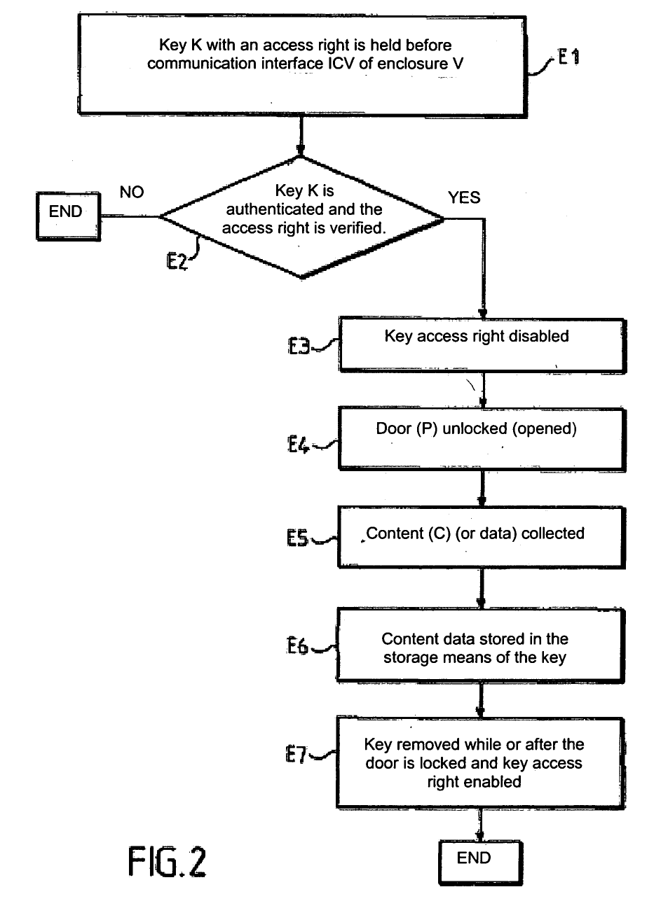

FIG. 2 is a chart illustrating the operating of the device according to the invention.

By reference to FIG. 1, content C is located inside enclosure V comprising a casing E that can prevent access to said content C.

Door P (preferably only one) provides access (preferably only one) to the inside of casing E.

Locking and unlocking means SDV are controlled by processing and control means OCV. The locking/unlocking means may be of the mechanical, logical or analogue type. For example, the OCV processing and control means are of the microprocessor or microcontroller type.

Memory OMV preferably saves the data relating to the tracking of content C. That memory OMV is particularly useful for containing data relating to the transactions completed with a terminal.

The data contained in the memory may be transferred to a key, which will be described in further detail below.

For example, memory OMV is of the EEPROM type.

As a variant, enclosure V also includes a communication interface ICV for communicating with the outside of the enclosure.

Communication interface ICV belongs to the group formed by contactless, contact or combined technology.

For example, the communication interface of the enclosure is of the type with no electrical contact, called the proximity type, where data are exchanged with a key located at a distance of a few millimetres.

The authentication function could for example be of the active type. It includes the exchange of data between the key and the enclosure using a communication protocol including encrypted and/or jammed communication.

The encryption/decryption of communication may for example use conventional cryptography functions of the triple DES (Data Encryption System) type.

The processing means IDV of the enclosure are able to establish an authentication function with the homologous authentication means of key K via enclosure communication interface ICV and homologous communication interface ICK of key K.

For its part, key K comprises a communication interface ICK that can communicate with homologous communication interface ICV of the enclosure. Also, key K has at least one access right. For example, the access right is a right to collect the content. Other access rights may be used as well.

Processing means IDK of the key can control the exchange of data via communication interface ICK. These processing means IDK are also capable of controlling reading and writing in storage means OMK. Storage means OMK can for instance save data relating to the tracking of content C.

For example, the processing means of the key are of the microprocessor or microcontroller type.

Memory OMK is for instance of the EEPROM type.

Key K may take the format of a smart card or equivalent. It uses contactless, contact or combined technology.

Power is supplied preferably by the enclosure, but it could be supplied by the key (power supply internal to the key) if the power supply of the enclosure fails.

By reference to FIG. 2, the securing device according to the invention functions as outlined below during an operation involving the collection of content C and/or data relating to the said content.

In stage E1, the operator holds key K before the communication interface ICV of enclosure V.

In stage E2, key K is authenticated by processing means IDV of the enclosure and processing means IDK of key K.

If the authentication and access right verification are positive (stage E3), collection can start using a predetermined protocol comprising exchange between the communication interface of the key and the communication interface of the enclosure till the door is locked.

The exchange is advantageously capable of providing information about the use of the key with the enclosure and/or disabling/enabling the access right and/or the means for authenticating the key on the basis of the use of the key with the enclosure.

If the collection process is not normal, for instance if the door is not locked, the processing means of the enclosure can disable the access right and/or the means for authenticating the key.

If the collection process is not normal, the processing means of the enclosure can also enable/disable the access right and/or the authentication means of the key. In practice, such disabling could occur before the door is opened and then be cancelled by reciprocal enabling if the door is closed normally.

In stage E4, the processing and control means OCV of the enclosure unlock (open) door P.

When the door is opened (stage E5), enclosure processing means IDV and/or OCV are capable of transferring content C and/or data relating to said content C from the transfer means (storage) OMV of the enclosure to key K of the enclosure via the communication interface ICV of the enclosure and homologous communication interface ICK of key K.

In practice, content C is transferred from transfer means OMV of the enclosure to the homologous storage means OMK of key K.

The data transferred in this way are first introduced in transfer means OMV by an internal system that controls the enclosure.

After the transfer of data, the user removes the key from the enclosure communication interface during or after the locking of door P.

Communication between the enclosure and the key is preferably achieved with no electrical contact, i.e. by induction. Such proximity key insertion in the lock offers additional protection from fraudulent eavesdropping in that the induction occurs inside the enclosure.

Communication between the enclosure and the key may be encrypted and/or jammed by session codes (randomly generated codes that are only valid during one opening session, when the key is present in the communication interface ICV of the enclosure).

In that way, during the time when the door is opened to have access to the content of the enclosure and also during the entire collection time, information is exchanged between the communication interface of the enclosure and the communication interface of the key.

As a result, it is possible to modify the access rights of the key if the collection process is not completed normally.

For example, the collection right of the key may be disabled if the key is removed while the door is not closed (enabling free access to the content of the enclosure).

With the access right of the key disabled, it can no longer be used by the operator to continue his/her round with other terminals, as the said terminals will not be unlocked.

Disabling the collection right also makes it possible to follow the trail of the operator, as the terminals retain the authentication codes of the keys presented to them.

For example, the validation or otherwise of the door opening command function occurs after a comparison of internal statuses between the key and the enclosure.

In stage E7, once the door is closed normally (locked), the access right or rights of key K can be enabled (the key microprocessor flag switches to low, which means that the key is enabled) using a protocol selected between the key and the enclosure.

Such information about the use of the key, with the disabling or enabling of the access rights of the key, particularly in synchrony with the opening/closing of the door makes it possible to keep track of any misconduct by an operator.

This invention may be applied to collect cash from any vending machine (parking terminal, ticket vending machine, beverage vending machine etc.). It may also be applied to access control or rounds, where the electronic key is used to prove that the various points have been visited (saving data such as the date time etc.).

1. Device for securing access to a content (C) located inside an enclosure (V), where the said enclosure is of the type comprising a casing (E) that is capable of preventing access to the said content, a door (P) that is capable of preventing access to the inside of the said casing (E) and means (SDV) to unlock door (P), characterised in that the enclosure also comprises a communication interface (ICV) with the outside of the enclosure, processing means (IDV, OCV) and transfer means (OMV) to transfer the content (C) or content data, which processing means (IDV, OCV) are designed to establish an authentication function with homologous authentication means (IDK) of key (K) offering at least one access right via the communication interface (ICV) of the enclosure and homologous communication interface (ICK) of key (K). If the access right is authenticated and verified positively, the enclosure processing means (IDV, OCV) are able to control the locking/unlocking means (SDV) to open the door (P) and if the door is opened, the processing means (IDV, OCV) of the enclosure are designed to transfer the content and/or data relating to the said content from the transfer means (OMV) of the enclosure to the key of the enclosure, via the communication interface (ICV) of the enclosure and homologous communication interface (ICK) of key K.

2. Device according to claim 1, characterised in that the processing means of the enclosure (IDV, OCV) are designed to transfer the content and or data relating to the said content from the transfer means (OMV) of the enclosure to the homologous storage means (OMK) of the key.

3. Device according to claim 1 or claim 2, characterised in that the authentication function is active.

4. Device according to any of the previous claims, characterised in that the communication interface (ICV) of the enclosure is of the type belonging to the group formed by contactless, contact or combined technology.

5. Device according to any claim from 1 to 4, characterised in that information is exchanged between the communication interface of the enclosure and the communication interface of the key till the door is locked, where the exchange is capable of providing information about the use of the key with the enclosure and/or enabling/disabling the access right of the key and/or the authentication means of the key depending on the use of the key with the enclosure.

6. Device according to claim 5, characterised in that if the collection process is not normal, the processing means of the enclosure are capable of disabling the access right and/or the authentication means of the key.

7. Device according to claim 5, characterised in that after verifying the access right and before opening the door, the processing means of the enclosure (IDV, OCV) are capable of disabling the access rights of the key, whereas if the door is closed normally, the processing means (IDV, OCV) of the enclosure are capable of enabling the access rights of the key.

8. Key designed to cooperate with a device for securing access to a content (C) located inside an enclosure (V) of the type including a casing (E) capable of preventing access to the said content, door (P) capable of preventing access to the inside of the said casing (E), processing means (IDV) and means (SDV) for locking/unlocking door (P), characterised in that the key (K) offers at least one access right and has a communication interface (ICK) designed to communicate with the homologous communication interface (ICV) of the enclosure, processing means (IDK) and storage means (OMK), where the said processing means (IDK) of the key are designed to establish an authentication function with the homologous authentication means (IDV) of the processing means of the enclosure, via the communication interface (ICK) of key (K) and the homologous communication interface (ICV) of enclosure (V). If the access right verification and authentication are positive, the locking/unlocking means are designed to open the door (P); if the door of the enclosure is opened, processing means (IDK) of the key are designed to transfer the content and/or data relating to the content from the transfer means of the enclosure (OMV) to the storage means of the key via the communication interface (ICV) of the enclosure and the homologous communication interface (ICK) of key (K).

9. Key according to claim 8, characterised in that information is exchanged between the communication interface of the enclosure and the communication interface of the key during all or part of the collection till the door is locked, where the exchange is capable of providing information about the use of the key with the enclosure and/or enabling/disabling the access right of the key and/or the authentication means of the key depending on the use of the key with the enclosure.

10. Key according to claim 9, characterised in that if the collection process is not normal, the access right and/or the authentication means of the key can be disabled.

11. Key according to claim 10, characterised in that after authenticating the key and verifying the access right and before unlocking the door, the processing means of the enclosure (IDV, OCV) are capable of disabling the access right of the key, whereas if door (P) is locked normally, the processing means (IDV, OCV) of the enclosure are designed to enable the access rights of the key.

12. Key according to claim 9, characterised in that the authentication function is active.

13. Key according to any claim from 9 to 12, characterised in that the communication interface (ICK) of the key is of the type belonging to the group formed by contactless, contact and combined technology.

14. Key according to any claim from 9 to 13, characterised in that it has the format of a smart card or an equivalent format.
